(19) United States
(12) Patent Application Publication
(10) Pub. No.: US 2011/0307307 A1
(43) Pub. Date: Dec. 15, 2011

(54) SYSTEMS AND METHODS FOR LOCATION BASED BRANDING

(76) Inventor: Akram Benmbarek, San Diego, CA (US)

(21) Appl. No.: 12/797,496

(22) Filed: Jun. 9, 2010

(51) Int. Cl. G06Q 30/00

(52) U.S. Cl. 705/14.4

(57) ABSTRACT

Systems and methods are disclosed for location based branding by checking into a business or a general location using a location based social network; determining if the business or other businesses in the neighborhood are running an advertising campaign and if so matching one or more influencers with a predetermined social influence (Social IQ) score with the available campaigns; and transmitting social influence messages from the influencers who have checked into the business location or into a general location.

### BACKGROUND

The present invention relates to location based branding.

Advertising is a form of communication used to inform potential customers about branded products and services, and to raise awareness of brands. Advertisers are constantly searching for improved ways of connecting with potential customers. Correspondingly, the ease of communication on the Internet has made it a natural place for user or members to post positive or negative reviews about products or services. Web sites such as complaints.com publicize consumer complaints. Consumers can leverage these resources to help solve their complaints. Complaints posted to Complaints.com are picked up by the search engines and have search result listings.

In a parallel trend, social networking services have appeared on the World Wide Web. These services provide online social networks for communities of people having common interests and/or activities, or who are interested in exploring the interests and activities of others. Recently, services from Foursquare broadcasts a user's location to his/her selected friends—it also serves as a game, pairing virtual rewards with real activities. Users earn badges as they visit different spots. Visit one location enough times and the user become the mayor. The user can use Foursquare to meet new friends, find out who else is in your area or compete against other people in your city.

Marketers and companies are quickly realizing that it's effective to know where consumers choose to go and purchase items rather than what they purchase. Foursquare is teaming up with neighborhood restaurants and chains to offer promotions for those who check in to their location with their app. One such example is their recent partnership with Starbucks. Thus, frequent Starbucks customers who check in at locations using Foursquare will earn customer rewards. In this sense, the business is hoping to use Foursquare to provide even more meaningful prizes, like invitations to special events, photo-sharing or online reputation scores. For businesses, a Foursquare “check-in” has become the equivalent of a new “fan” on a Facebook fan page.

### SUMMARY

Systems and methods are disclosed for location based branding by checking into a location, which could be specific such as a business or a general location such as a neighborhood, using a location based social network; determining if the business or businesses in the neighborhood are running an advertising campaign and if so matching one or more influencers with a predetermined social influence (Social IQ) score with the campaign and targeted advertisements; and transmitting social influence messages from the influencers who have checked into the business or general location.

Implementations of the above aspects may include one or more of the following. The system includes informing the business of the possibility to create a new advertising campaign. The system can determine whether the influencer is eligible to participate in a campaign and if so offers the influencer an opportunity to participate in a campaign and to earn awards or money. This can be done by providing an incentive for the influencer to post content. The system can pay the influencer and also debit an account associated with the business. The system can identify neighboring businesses in the neighborhood matching the influencer's preferences with available services at the neighboring businesses. The system can inform businesses in a neighborhood of a possibility of advertising to users or members in the neighborhood receive a commitment from one of the neighboring businesses and post advertising to eligible users or members depending on the influencer's action. A social network to communicate user's or member's interests and influences how services are provided or how products are made. A web application can be used such as a social network application, an instant messaging application, or a real-time short messaging service. The web application works over multiple networks and devices. The system validates the customer as an actual buyer of the product or service. The users can invite social network members to vote. Members of third party social networks can vote on the same provider. Filtered advertising can be shown to the customer. The system can specify a level of advertising to be received from the providers' competition. The user can earn social influence capital on a point system. The system can modify the social influence capital based on a user's or member's activity on the brand scoring and ranking. The social network can communicate users' or members' interests and influences how services are provided or how products are made. The system includes a measurement system for measuring social influence power of users or members (Social IQ). The Social IQ measures a user's or member's ability for influencing brands of products or services across the different stages of a product or a service life cycle. The users or members can share a Consumer Experience (CXS) on line. Users or members can share review on a specific service purchased, vote a level of satisfaction, and invite friends on social networks to see the review and vote along. The user can share a need online through a need sharing application. The user or member shares the item being shopped for and can receive aggregated reviews from top review site, and shopping assistance from friends and connections on social networks sites who will share available deals they find both online and offline. The system can gather advice and collective bargaining power by grouping people with the same need as one buyer. The system provides access to need groups and group forums that may help him/her satisfy their need. The system can maintain a wish list for unmet need and receiving notification of a match for the unmet need by a product or service provider.

In another aspect, systems and methods are disclosed to share a customer experience with a network of users or members by displaying one or more industry categories on a rotating basis on a display screen; displaying a customer experience rating for a company's service or a product; rating a provider of the service or product based on a customer's experience; sharing the customer experience with a social network of users or members using a web application; and inviting other members to vote on the provider.

In yet another aspect, a system creates a market for social influence, by 1) creating a measurement system and pricing mechanism for the social influence power (Social IQ) which is, in the marketing industry, the ability to influence brands of products and services at different level of the marketing vertical from market research to advertising; and 2) establishing a market place to trade social influence and its derivative products such as: Opinion sharing, reviews, expert advice, endorsement, promotion, content generation, and buzz creation. The system can measure Social IQ and supports monetization of social influence through Social IQ.

In yet another aspect, a marketplace is provided. The marketplace is an e-commerce exchange where Marketers acquire content and advertising channels. The market place is also where users or members sell their influence to advertisers both by brands and by geographical location. The Marketplace enables marketers to acquire digital real estate where they can display their advertising (videos, text content, and widgets), they can also benefit from integrated capabilities for their marketing and ad campaigns, including business intelligence. Businesses have access to “Geo Adpush” which is a location based (geo) advertising marketplace application that they can use to advertize and run awareness campaigns through influencers who patronize their establishments or who are simply in the neighborhood. The system allows targeted advertising to be done through the Market place. The system also supports targeted advertising and intelligence gathering through Geo Adpush.

### BRIEF DESCRIPTION OF THE DRAWINGS

FIG. 1 shows a block diagram of a brand influence social network system.

FIG. 2a shows a table with a high level description of Social IQ measurement system.

FIG. 2b shows a block diagram of social IQ scoring system.

FIG. 2c Shows the seven levels of influence and relates them to Social IQ.

FIG. 3a shows a high level description of the customer experience sharing (CXS) application.

FIG. 3b shows an exemplary workflow for experience sharing engine.

FIG. 3c thru FIG. 3i show an exemplary user or member interface for an experience sharing engine.

FIG. 4a shows a high level description of the need sharing (NS) application.

FIG. 4b shows an exemplary workflow for need sharing engine.

FIG. 5a shows a high level description of the social influence market place.

FIG. 5b shows an exemplary workflow for the market place.

FIG. 5c shows an exemplary workflow for marketing campaign creation engine.

FIG. 6a shows a high level description of Geo Adpush application.

FIG. 6b shows an exemplary workflow for the Geo Adpush engine.

FIG. 7 shows an exemplary computer system that supports the brand influence social network system.

### DESCRIPTION

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

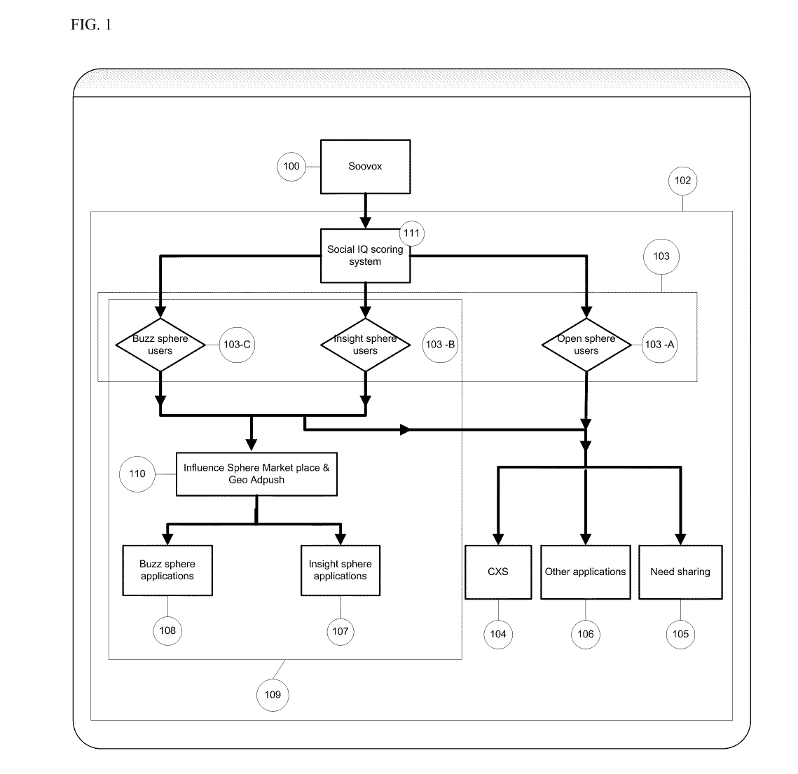

FIG. 1 shows an exemplary block diagram of a brand influence social network system (100), according to an example embodiment. The system of FIG. 1 enables brands to be promoted efficiently in an online social network environment. Such embodiments leverage social networks to provide more relevant and interesting power to the consumer as the agent of change.

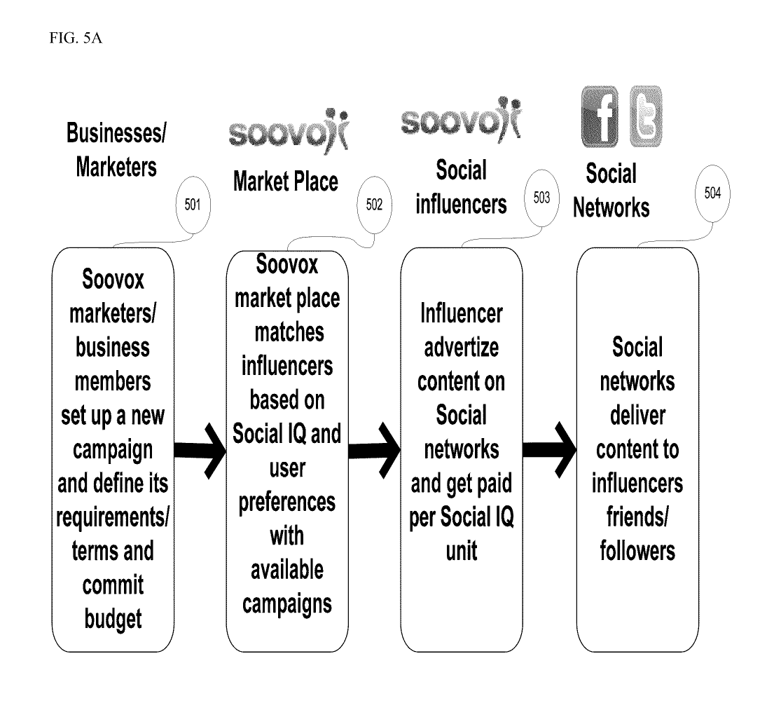

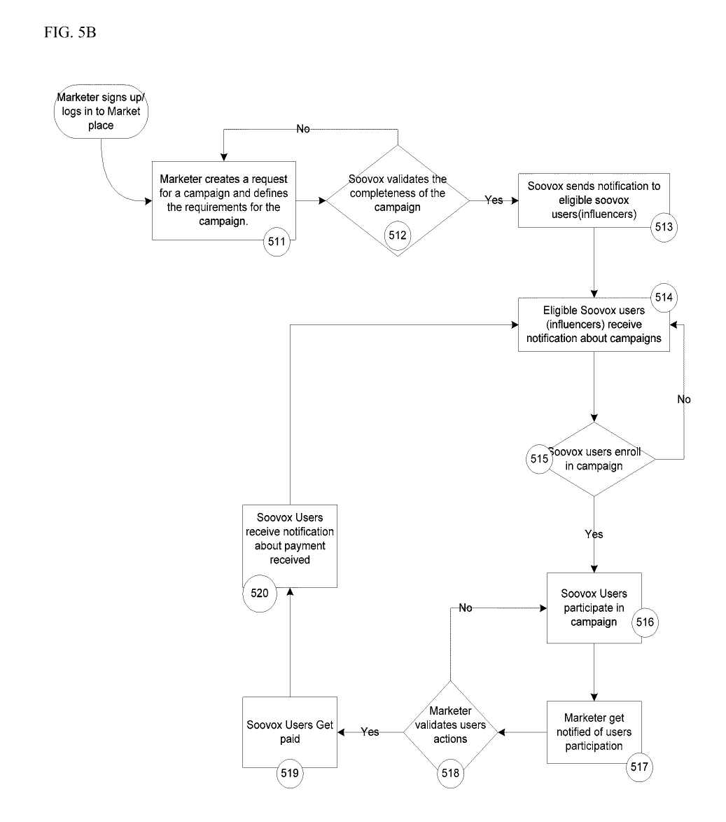

One embodiment called Soovox (Su Vox being Spanish for your voice) is an internet environment that leverages social networks and web systems to give the consumer a significant voice that influences the way services are provided and the way products are made, and that helps the buyer get the right help to get the best deal in his/her shopping experience above and beyond the current product review applications that are offered on the web today. Through the platform, Soovox disrupts the advertising industry and creates new mediums for companies to advertise while being very close to the consumer and able to monitor money spent in the promotion of the product. Soovox includes a system for measuring Social Influence power namely Social IQ which enable monetization of social influence. The system is a web environment where the user or member engages the web community to influence brands of products and services at multiple levels ranging from a structured but simple product review with the purpose of thanking or trashing a brand, all the way to large scale influence through innovative advertising widgets. In order to maintain the user or member engagement, Soovox environment provides several applications offered with a hierarchical system that reserves the access to financially rewarding applications, to user or members that achieve a certain web social status, assessed via Social IQ. In one implementation, main applications include:
Social IQ Scoring application—a measurement system for measuring social influence power of user or members. Social IQ is a metric to measure the ability of influencing brands of products and services across the different stages of a product or a service life cycle.
Consumer Experience Application (CXS)—a consumer experience sharing application that allows the user or member to share review on a specific service purchased, vote a level of satisfaction, and invite friends/connections on social networks to see the review and vote along. User or member can suggest to add a new brand if it does not exist on the list.
Need sharing Application—a shopping assistance application where the user or member shares the item he/she's shopping for, to receive aggregated reviews from top review sites, and shopping assistance from friends on social network sites who will share available deals they find both online and offline. The goal of this application is to get advice and collective bargaining power by grouping people with the same need as one buyer. The user or member will also have access to need groups and group forums that may help him/her satisfy their need. The user or member can also maintain a wish list for his unmet needs and get notified in case there is a match for her/his need by a product or service provider.
Influence Sphere Marketplace Application—an influence platform where eligible users or members get to influence brands, products, and services by either, providing insights and opinions on product testing and market research projects, or for more influential users or members to promote and advertise brands they care about. In one implementation shown in FIG. 5a, the Influence Sphere includes:
   Insights sphere: An exchange to match data gatherers with the appropriate respondents required to share insights and answer surveys. Matching will be carried through appropriate segmentation of the population of respondents who belong in the Insight sphere.
   Buzz sphere: An exchange to match brands with social influencers with specific criteria to advocate for products and services to promote them on social media. Identification and Segmentation of the population of social influencer who belong in the Buzz sphere will ensure a perfect match with the brands to be promoted on social media.
Geo Adpush application—a location based version of the Influence Sphere Marketplace Application which leverages location based social networks like Foursquare and Gowala to originate the advertising opportunity for the businesses, and connect them with the influencers to make a micro advertising deal or get business intelligence.

As shown in FIG. 1, the Soovox social network system (100) includes a social network (102) with members (103-A, B and C), a social IQ measurement engine (111), an experience sharing engine (104), a need sharing engine (105), and an influence engine (109). All engines are coupled to major social networks (102) by communication interfaces. The system (100) enables users or members (consumers) and brands to interact.

The system (100) of FIG. 1 provides a global exchange for market intelligence and market influence. The system (100) leverages social networks, web communities, and powerful web technologies to enable users or members to be the agents of change and positive influence, across the whole marketing vertical from market research to advertising. Through the system, consumers and brands will exchange different types of content that lead to better products, better sales, and higher customer experience.

Social network (102) is an online social network or a combination of social networks that includes a community of users or members (103 A-B-C) (network participating people). Social network (102) may include any number of users or members (103), including hundreds, thousands, or even millions of users or members (103). Users or members (103) may interact with each other in social network (102) using corresponding electronic devices (e.g., computers, cell phones, etc.), as described in detail further below. Social network (102) operates within a communications network, such as a local area network (LAN), a wide area network (WAN), or a combination of networks, such as the Internet. For example, social network (102) may be based in the World Wide Web. The communication network enables communications between users or members (103). Social network (102) may enable one or more ways for users or members to interact, including enabling communications between users or members (103) through one or more of blogging, discussion groups, email, file sharing, instant messaging, online chat, video, voice chat, and/or other user or member communication mechanisms.

Each user or member (103) has corresponding user or member information. User or member information may include any information about the respective user or member (103) that the user or member may desire to make accessible to other users or members (103) of social network (102). For example, user or member information may include a name and/or an alias, a representative image (e.g., a photographic image and/or avatar), contact information, status information, a list of interests, and/or other information regarding the respective user or member (103). User or member information may be configured to support a self-description page (also referred to as a “user or member profile page”) for each user or member (103), which may be displayed as a web page or in other form. In an embodiment, user or member information may include a list of friends of the user or member. For example, user or member in the group (103-A) may include user or members in (103-B or C) as friends and a list is maintained in user or member information. In an embodiment, social network (102) may enable each user or member (103) to link their profile pages with the profile pages of their listed friends.

All users or members in (103-A, B, C) can use applications (104, 105 and 106). The communication interfaces may include any type and/or combination of communication links, including wired and/or wireless links, such as IEEE 802.11 wireless LAN (WLAN) wireless links, Ethernet links, USB links, etc. In an embodiment, brand engine (104) may include one or more network interfaces, including wired or wireless interfaces, such as an as IEEE 802.11 wireless LAN (WLAN) wireless interface, an Ethernet interface, a USB interface, etc. Applications (107 and 108) can only be accessed through the market place (110) by users or members from (103 B, C) where the same principles of access described above for applications (104, 105 and 106) apply.

The system discussed above may be implemented in a variety of ways. For example, in one embodiment, the system may be configured to manage all user or member information for each user or member of the social network, as well as manage distribution/sharing of brands. For example, the social network engine is communicatively coupled with user or member devices through a network which may be a LAN, a WAN, or combination of networks, such as the Internet. Exemplary user or member devices include a desktop computer, a mobile computing device, or a mobile phone. The desktop computer may be any type of stationary computer mentioned herein or otherwise known, including a personal computer. The mobile computing device may be any type of mobile computing device, including a mobile computer (e.g., a iPhone® device, a personal digital assistant (PDA), a laptop computer, a notebook computer, etc.) or a mobile email device (e.g., a RIM Blackberry® device). The mobile phone may be any type of mobile phone, including a cell phone. The user or member devices may include any number and type of devices that users or members may use to interact with the system or with the social network. Each user or member device may communicate with the system through a corresponding communication link. For example, the desktop computer can be communicatively coupled with the system through a first communication interface, the mobile computing device can be communicatively coupled with the system through a second communication interface, and the mobile phone can be communicatively coupled with the system through a third communication interface. The communication interfaces may include any type or combination of communication links, including wired and/or wireless links, such as IEEE 802.11 wireless LAN (WLAN) wireless links, cellular network links, wireless personal area network (PAN) links (e.g., Bluetooth™ links), Ethernet links, USB links, etc.

The social network service enables the formation of communities of users or members, and manages the user or member communities. For example, the social network may enable users or members of to interact with each other in any number of ways, including blogging, discussion groups, email, file sharing, instant messaging, online chat, video, voice chat, and/or other techniques. For instance, the social network can be Bebo (www.bebo.com), Classmates.com™ (www.classmates.com), Facebook™, (www.facebook.com), LinkedIn™ (www.linkedin.com), MySpace.com™ (www.myspace.com), Twitter (www.twitter.com), or any other social network service.

The application in FIG. 1 provides a market place (110) to trade social influence and its derivative products such as: Opinion sharing, reviews, expert advice, endorsement, promotion, content generation, and buzz creation. This Market is a means by which marketers have access to influencers. Influencers get paid based on their Social IQ for providing influence in their social network on behalf of the marketer. Each unit of Social IQ will have a corresponding monetary value which can also be subject to bidding in the market place. Higher social IQ increases the worth of influencers in the market place and gives them more bargaining power. Specifics of the Market place will be detailed below.

As described above, user or member information for each user or member from (103) may include various types and amounts of information. The user or member information included in user or member information for each user or member from (103) may be actively provided by a user or member, collected from user or member devices through social network (102) and/or another channel, provided from some other network, system or database that aggregates such data, or by any combination of the foregoing. User or member information may be included in a file or other data structure. Each element of user or member information may be one or more data fields, data records, or other type of data entry in a data structure. Social data may be any data or metadata relating to the relationships of a user or member of an electronic device. For example, social data may include user or member identity data, such as gender, age, race, name, an alias, a status of the user or member (e.g., an online status or a non-online related status) (e.g., at work, at sleep, on vacation, etc.), a social security number, image information (such as a filename for a picture, avatar, or other image representative of the user or member), and/or other information associated with the user or member's identity. User or member identity information may also include e-mail addresses, login names and passwords. Social data may also include social network data. Social network data may include data relating to any relation of the user or member that is input by a user or member, such as data relating to a user or member's friends, family, co-workers, business relations, and the like. Social network data may include, for example, data corresponding with a user or member-maintained electronic address book. Certain social data may be correlated with, for example, location information to deduce social network data, such as primary relationships (e.g., user or member-spouse, user or member-children and user or member-parent relationships) or other relationships (e.g., user or member-friends, user or member-co-worker, user or member-business associate relationships) and may be weighted by primacy. For example, social data may include relationship information. Relationship information includes a list or other data structure indicating friends of the user or member, including friends that are other users or members (103) participating in social network (102). Relationship information may include categories for the indicated friends, such as “relatives,” “spouse,” “parents,” “children,” “cousins,” “best friends,” “boss,” “co-workers,” and/or any other suitable category.

The user or member information may include data or metadata concerning subject matter in which a user or member of an electronic device appears to have an interest or is otherwise associated. Topical data may be actively provided by a user or member or may be derived from other sources. For example, topical data may include one or more transaction log(s) of transactions involving the user or member. For example, transaction log(s) may include logs of searches (e.g., query lists/results lists) performed by the user or member, logs of commerce undertaken by the user or member, logs of website/webpage browsing by the user or member, logs of communications (e.g., with friends in social network (102)) by the user or member, etc. As used herein, the term interaction data refers to any data associated with interactions carried out by a user or member via an electronic device, whether active or passive. Examples of interaction data include interpersonal communication data, media data, transaction data and device interaction data. Interpersonal communication data may be any data or metadata that is received from or sent by an electronic device and that is intended as a communication to or from the user or member. For example, interpersonal communication data may include any data associated with an incoming or outgoing SMS message, e-mail message, voice call (e.g., a cell phone call, a voice over IP call), or other type of interpersonal communication relative to an electronic device, such as information regarding who is sending and receiving the interpersonal communication(s). As described below, interpersonal communication data may be correlated with, for example, temporal data to deduce information regarding frequency of communications, including concentrated communication patterns, which may indicate user or member activity information. Media data may be any data or metadata relating to presentable media, such as audio data, visual data and audiovisual data. Audio data may be, for example, data relating to downloaded music, such as genre, artist, album and the like, and may include data regarding ringtones, ring backs, media purchased, playlists, and media shared, to name a few. Visual data may be data relating to images and/or text received by an electronic device (e.g., via the Internet or other network). Visual data may include data relating to images and/or text sent from and/or captured at an electronic device. Audiovisual data may include data or metadata associated with any videos captured at, downloaded to, or otherwise associated with an electronic device. Media data may also include media presented to a user or member via a network, such as via the Internet, data relating to text entered and/or received by a user or member using the network (e.g., search terms), and data relating to interaction with the network media, such as click data (e.g., advertisement banner clicks, bookmarks, click patterns and the like). Thus, media data may include data relating to a user or member's RSS feeds, subscriptions, group memberships, game services, alerts, and the like. Media data may also include non-network activity, such as image capture and/or video capture using an electronic device, such as a mobile phone. Image data may include metadata added by a user or member, or other data associated with an image, such as, with respect to photos, location at which the photos were taken, direction of the shot, content of the shot, and time of day, to name a few. As described in further detail below, media data may be used for example, to deduce activities information or preferences information, such as cultural and/or buying preferences information. Interaction data may also include transactional data or metadata. Transactional data may be any data associated with commercial transactions undertaken by a user or member via an electronic device, such as vendor information, financial institution information (e.g., bank information), financial account information (e.g., credit card information), merchandise information and cost/prices information, and purchase frequency information, to name a few. Transactional data may be utilized, for example, to deduce activities and preferences information. Transactional information may also be used to deduce types of devices and/or services owned by a user or member and/or in which a user or member may have an interest.

The interaction data may also include device interaction data and metadata. Device interaction data may be any data relating to a user's or member's interaction with an electronic device not included in any of the above categories, such as data relating to habitual patterns associated with use of an electronic device. Examples of device interaction data include data regarding which applications are used on an electronic system/device and how often and when those applications are used. Device interaction data may be correlated with temporal data to deduce information regarding user or member activities and patterns associated therewith.

The application described in FIG. 1 measures “The social IQ: The social influence quotient” (111) which is a proprietary metrics to measure the ability of influencing brands of products and services across the different stages of a product or a service life cycle. Influence can be exercised at the conception level through but not limited to insight/opinion on design preferences, feature preferences, and market needs. Market surveys, brand forums, and product conversations are usually the preferred method to exercise this kind of influence. Influence is also exercised during the buzz creation and the promotion of the product/service in the market through endorsement, word of mouth and dissemination of promotional content like advertising literature, blogs, videos, and vlogs among others.

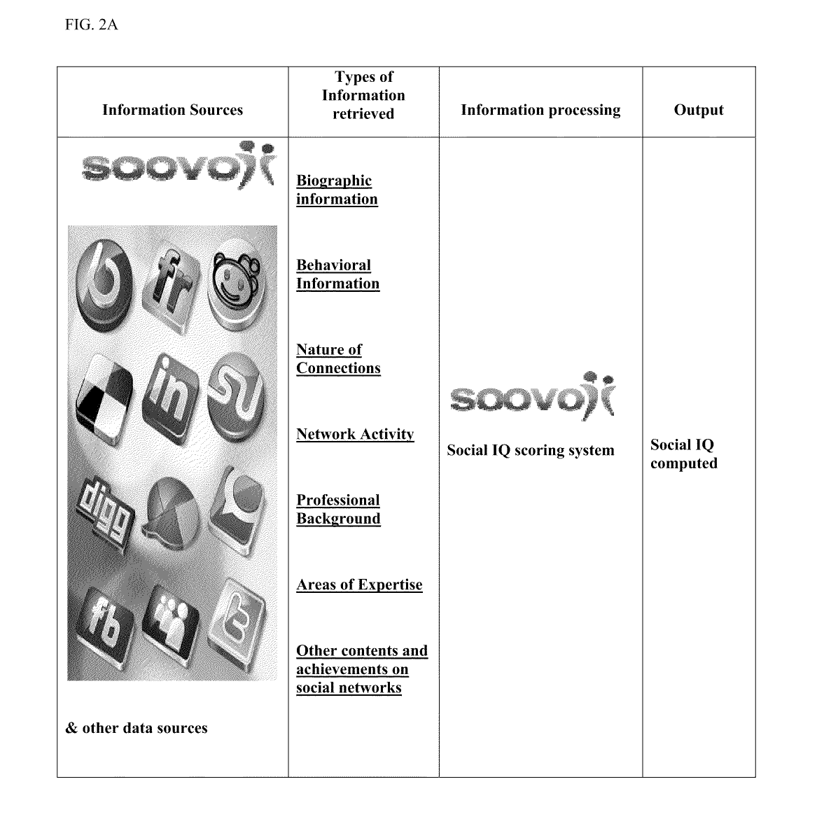

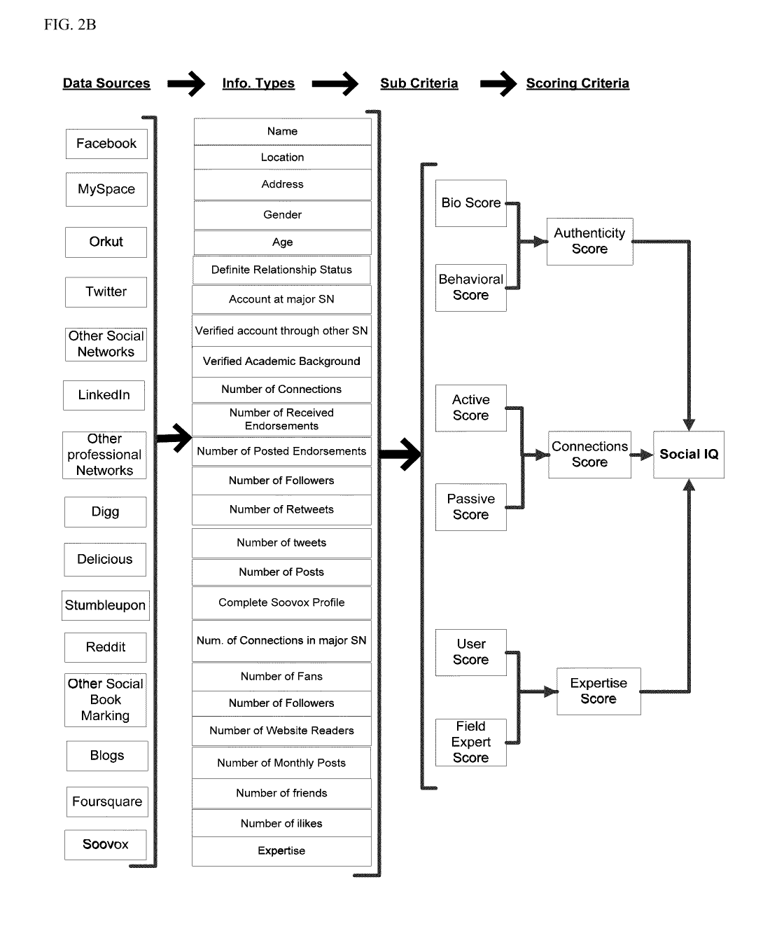

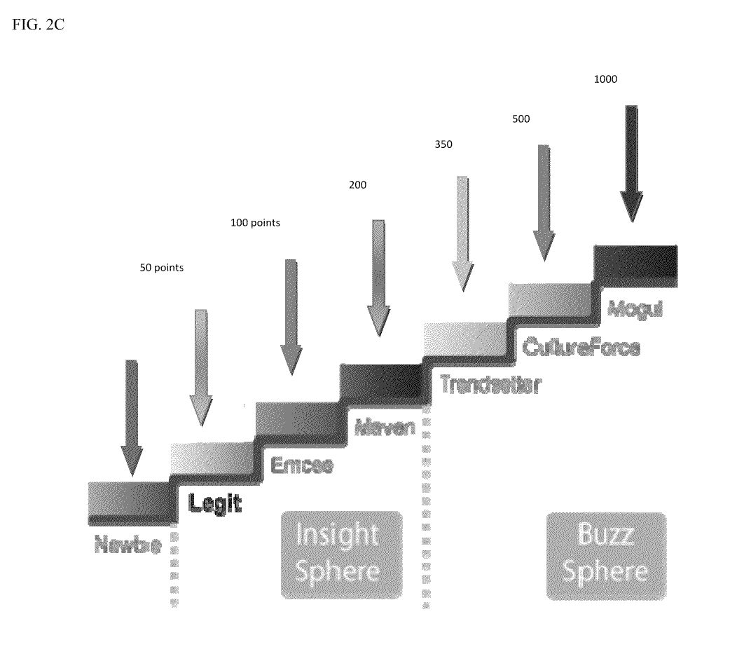

Next, the Social IQ Module shown in FIGS. 2a, 2b, and 2c will be discussed in detail. FIG. 2a gives a high level description of the social IQ module; the column on left side identifies the different sources of information required to compute Social IQ, these data sources include major social and professional networks, Social bookmarking sites, blogs, location based social networks and may include other sources of information when deemed relevant. The following column lists some the information collected from the different data sources which includes the user or member's biographic information, behavioral Information, the nature of his/her connections, their network activity, professional background, area(s) of expertise in addition to other contents and achievements information on social networks. All this information is then processed to compute the Social IQ as described in FIG. 2b.

The social IQ module relies on the following three main scoring criteria related to the demographic, behavioral, Psychographic traits of the user or member to come up with a final score called Social IQ:
1—Authenticity: which is assessed based on biographic, and behavioral information about the user. This criterion is used by the system to measure the user's or member's credibility with regard to his/her biographical data and social network activities referred to as behavioral authenticity.
2—Connections: this criterion looks at both passive and active aspects of users' connections. It expresses the nature of the user's or member's connections in major social networks: Facebook, Twitter, LinkedIn and Orkut to differentiate between users or members with stagnating, passive, connections and active socially engaged users or members. The system uses this differentiation to detect future social influencers who would be engaged in impacting product/service branding.
3—Expertise (knowledge): users are evaluated as consumers, and/or as professional. The Social IQ application gives credit to users or members depending on their level of expertise and how they use it throughout Soovox's applications. This criterion differentiates between the skills that users or members may master thanks to their academic or professional background and the ones that they have acquired by using different social networks such as Facebook and Twitter.

Referring to FIG. 2b, the social IQ of a user or a member is calculated using a nonlinear combination of the three sub criteria scores defined by the social IQ scoring system. The sub criteria (authenticity, connections, expertise) scores are obtained using different nonlinear combinations of the coefficient factors of data falling under each category.

Starting from the left side of the social IQ diagram (FIG. 2b), each piece of information, take name for instance, is collected from a specific source, usually one of the major social networks: Facebook, Twitter, LinkedIn or Orkut but could also come from others such as Jaiku, MySpace and so on. In this case, name is assigned a coefficient factor that is used along with other coefficient factors (location, address, gender . . . ) to compute the biographical score (E) of the user or member. The same method is applied to get the behavioral authenticity score (F) for data under this category: academic background, connections, endorsements and so on (refer to FIG. 2b). (E) and (F) are then used by the system to obtain the authenticity score of the user or member (A). Following the same technique, the system works out the user's or member's connections' score (C) and Expertise score (E). Finally, (A), (C) and (E) are involved in the final social IQ score of the user or member.

In the social IQ diagram (FIG. 2b), each piece of information in the “info types” column is linked to its source in the sources column and to the category to which it belongs in the sub criteria column which is itself linked to one of the three criteria: Authenticity, Connections and Expertise. For example, the user's or member's academic background is verified through his/herLinkedIn account and is used in both biographical authenticity and field expertise.

The high level equation to compute the Social IQ includes four sub scores and several coefficients all based on the information described above and are explained below:
The Base Score quantifies basic information about the user or member;
The Insight Score reflects a weighted average of the level of the user's or member's activity in major social networks such as Facebook, Myspace and Orkut and is also based on their twitter activity.
The insight score is down weighted by the following two coefficients:
   Account verification coefficient (AVC) which reflect how credible is the user's or member's basic information through verification via at least one of his social network accounts
   Insight Qualification Coefficient (IQC) reflect to what extent the user or member meets the requirements to get into the Insight sphere
The Other Basics Score quantifies basic information other than the one taken into account in the base score, such as relationship status
The Buzz Score gauges the user's or member's ability to be influential on social networks and is computed as the sum of a LinkedIn score, a blog score, a Soovox Score, a CXS Score, a Foursquare Score, a Digg Score and other social book marking sites scores.
   The Insight score, buzz score and other basic scores are down weighted by the Buzz Qualification Coefficient (BQC) when the user or member does not meet the requirements to get into buzz sphere.

In one implementation, the social IQ score is computed as explained in Equation 1 below.

Social IQ Score=Base Score+AVC^{—}xIQC_x[Insight Score^{BQC}+Other Basics Score^{BQC}+Buzz Score^{BQC}] Equation 1

The user's or member's Social IQ grows over time (by posting interesting content in his favorite networks, growing his connections across the social web, inviting his friends to Soovox, tweeting or posting his Social IQ . . . ). As the score increases the user or member gets access each time to higher levels of influence on the Social IQ staircase which includes seven levels and two major spheres as shown in FIG. 2c. Social IQ may also decrease overtime if the user's or member's activity on social networks decreases over time.

The seven levels in the Social IQ staircase in the implementation of FIG. 2c are further explained next. First, all new Soovox users or members whose social IQ is lower than 50 points belong in the open sphere and are classified as a Newbie. Once their score exceed 50 points, they enter the Insight sphere which includes three levels of influence; Legit, Emcee and Maven. The Legit level includes users or members whose Social IQ is lower than 100 points. They turn into an Emcee when their score reaches 100 points. Users or members classified as a Maven have a Social IQ of at least 200.

The social IQ required to enter the first level of the Buzz sphere and earn the title of a Trendsetter is 300 points. The next level in the Buzz sphere labels its members Culture force and requires a Social IQ of 500 points. The upper level of the Buzz sphere and of the Social IQ staircase includes social influencers, labeled at this level Mogul, with a Social IQ of at least 1000 points.

The structure of the Social IQ measurement system presented herein is modular in nature and is prone to including new modules to account for other emerging components of the social media landscape that may become relevant to assessing individual's Social IQ.

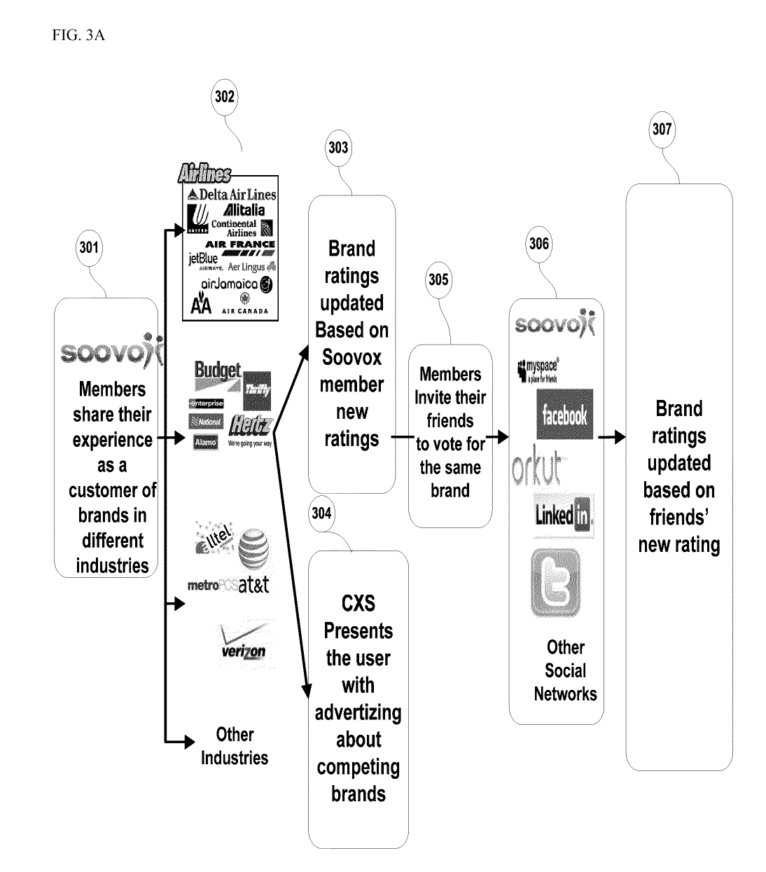

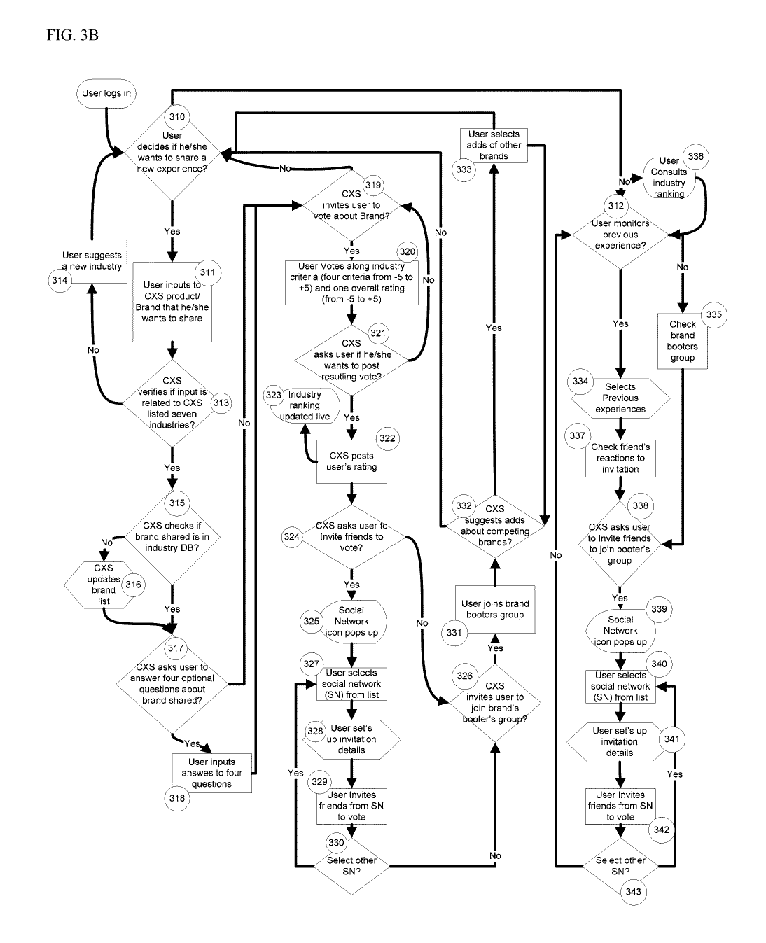

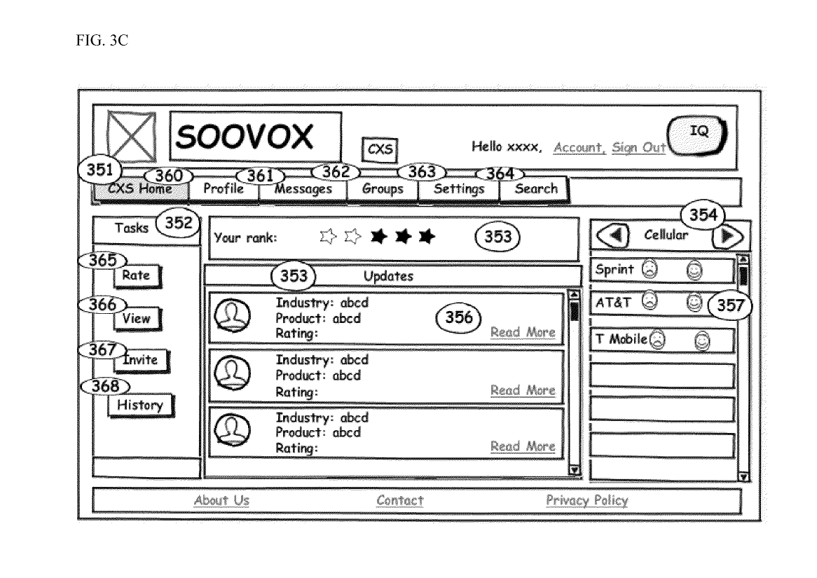

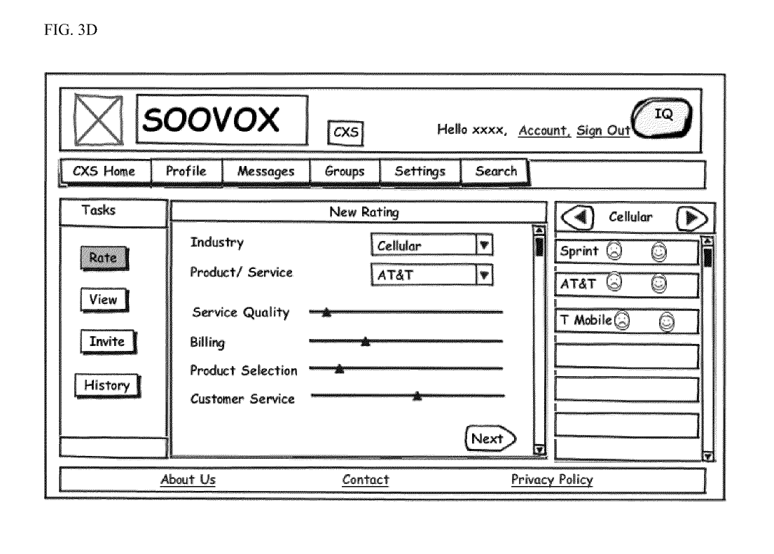

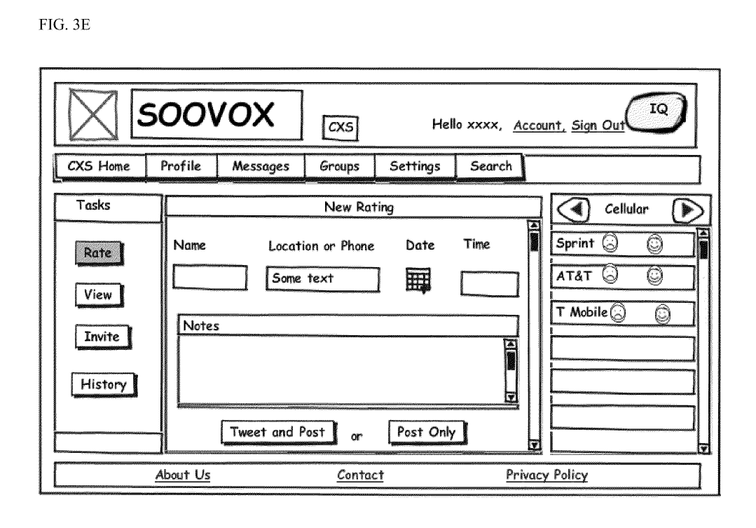

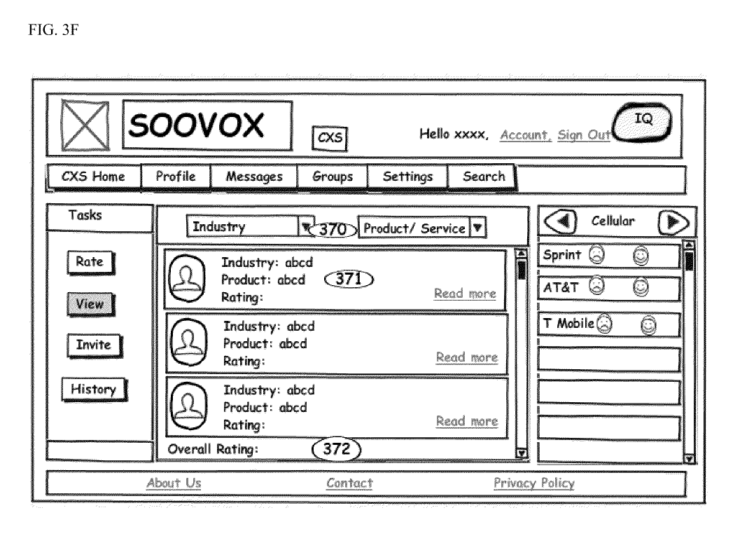

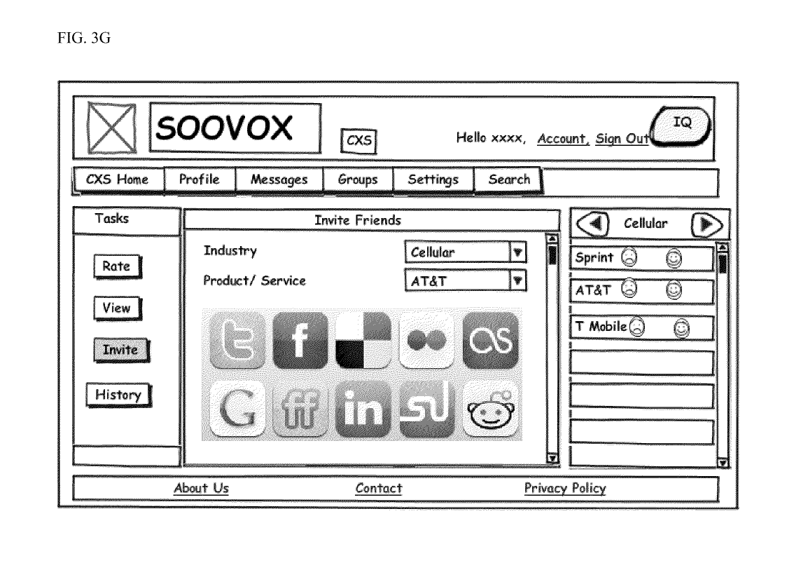

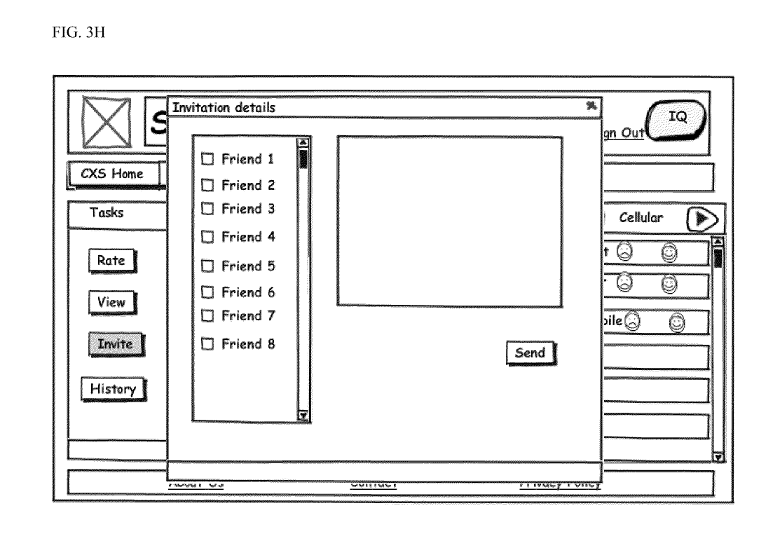

The application described in FIG. 1 includes also the customer experience sharing engine CXS (104). A description of the CSX Sharing module (FIGS. 3a through 3i) is detailed next. The system allows the user or member to share a product/service experience with motivations, objectives, and consequences that are very different from existing review tools. In fact the application may leverage existing review tools, along with existing social networks, and existing web technologies to perfect the user's or member's experience. In one embodiment, the application enables users or members to:
1. Get the voice heard loud by posting a quantitative feedback for a brand's product/service and impact the brand rating and ranking
2. Track brands' rankings among their competitors for different industries thanks to a live billboard
3. Leverage social networks to invite friends to join the user or member in a petition if they share the same opinion.
4. Form a cluster of friends to have a powerful bargaining voice and impact further the brand through the cluster of friends brought on board for the petition.

In one implementation, the customer experience ranking can be summarized as a brand rating in seven exemplary industries including wireless carrier services, Internet and TV service providers, insurance providers, hotels, banking institutions, rental car services, and airline companies.

The system allows users or members to effect positive change in products and services they consume to maximize customer satisfaction. The system works with social networking environments and takes advantage of the social network to provide more relevant, interesting, and variable advertising to the social network participants.

In this implementation, starting at the home page, prior to the user's or member's login, the system shows a vertical board that is streaming brand rankings in each industry, in this case seven industries, one after the other. Every industry ranking will be shown for a predetermined duration such as 4 seconds. The brand rankings are streamed continuously to give space to another industry ranking to stream in. The ranking board will show the brand names from top to bottom starting at the top with the most recommended brand by users or members to the least recommended brand. It will also show how many boosters (+) and how many booters (−). An arrow will be aiming at the board and inviting users or members to share and vote. Then users or members can sign in or sign up to share their experience.

The application enables the user or member to share a structured “service experience” that is coupled with a numerical rating that will affect the product brand rating for the industries. The rating can be magnified by inviting the community members to join the campaign, if they happen to share the same opinion on that specific brand. Invitees can come from the system itself, Facebook, other social networks, or Twitter followers. The votes are aggregated to post a collective vote on brand. That brand will be ranked among its peer competitors. Once the opinions and votes are aggregated on one subject, users or members may be invited by competitive brands to explore deals; discounts can be offered to satisfy this cluster of unhappy customers.

FIG. 3a gives a high level description of the customer experience sharing engine where Soovox members (301) set out to share their experience with a brand from a given industry, Soovox members can share their experiences about the industries/brands (302) listed in CXS including airline, car rental, wireless industries. They can also suggest new brands/industries and post their experiences. CXS updates the industry/brands ranking based on user's or member's rating (303) and also presents Soovox members with advertising (about competing brands) related to their experience (304). Through CXS, Soovox members can also invite (305) their friends/connections in social networks (306) to vote about the same brand, which will lead to changing the brand/industry rating (307).

FIG. 3b shows details of an exemplary workflow for CXS. First, a user or member logs into the system. Next the system checks whether the user or member wants to share a product or service experience with others (310). If not, the system checks if the user or member wishes to monitor previous experiences (312). From (312), the system allows the user or member to select a prior experience (334). Next, the user or member can check friends' reactions to invitations (337). If so, the system verifies if the user or member wants to invite friends to join booter's group (338). If so, the system displays one or more social network icons (339). The user or member can select a social network (340), set the invitation details (341) and send the invitation (342). The system then checks if the user or member wishes to select other social networks (343). If not, the system moves back to (312) where the user or member can monitor and track previous experiences. Otherwise, the system loops back to (340) for the user or member to select other social networks. From (312), if the user or member does not want to monitor previous experiences, the system displays brand booters groups for the user or member to consult (335) and invite friends to join (338). The user or member can invite friends to join brand booters group either by checking the group (335) or by checking previous friends' reactions to invitations (337). (338) can be reached both from (335) and (337).

From (310), if the user or member wants to share a product or service experience with others, he/ she inputs the brand to be shared (311). The system verifies if the input is related to the seven listed industries (313) and if the brand shared is part of the industry data base (315). If not, the system updates the brand list with the user or member input (316). Otherwise, the system prompts the user or member to answer four optional questions about him/herself (317). The user or member can either input the answers to the four questions (318) or go directly to vote about the brand (319). If the user or member chooses not to vote, the system loops back to (310) to question the user or member about his/her sharing intentions. Or, the user or member can vote along four industry criteria from −5 to +5 in addition to an overall rating in the same numerical range (320). The system asks the user or member to post the resulting vote (321). If not, then the system goes back to (319). If yes, the industry ranking is updated (323) and the user's or member's vote is posted by the system (322). After this step, the system asks the user or member to invite friends to vote for the brand (324). If so, the user or member can select a social network (327), set the invitation details (328) and send the invitation (329). The system then checks if the user or member wishes to select other social networks (330). If not, the system invites the user or member to join brand's booters group (326). From (324), if the user or member does not want to invite friends to vote, the system moves directly to (326).

From (326), the user or member is asked to join brand booters group (331) or go back to (310). After joining the group, the system suggests ads about competing brands for the user or member to choose from (332). If yes, the user or member selects ads of other brands (333) then goes back to (310). Otherwise the system loops back to (310).

FIG. 3c represents the experience sharing engine landing page. It allows the user or members to consult products/ services rankings across seven industries (Wireless carrier services, Internet and TV service providers, Insurance Providers, Hotels, Banking institutions, Rental car services, Airline companies), share experience by rating products/ services, invite friends and join group brand groups, receive ads.

The system includes a basic menu bar (351) from which users or members can perform different actions. From (360), the user or member has access to a personal profile and can view it or edit it. Point (361) is for the user or member to consult and exchange messages with other users or members. Groups are accessible from point (362) from which the user or member can join groups and invite friends to join the as well. Parts 363 and 364 deal with the system settings and search, respectively. In addition to this, the system offers experience sharing major functionalities from a side menu bar (352):
Rating product/service: (365).
Viewing user or members' ratings activities: (366).
Inviting social networks friends to rate product/service: (367).
Consulting personal rating history: (368).
   (353) is a ranking bar that displays the ranking of the user or member among other user or members of the system.

The industry ranking table, major system functionality, is displayed in part 4. The ranking displays brand's ratings from most recommended to least recommended according to CXS user or members. User or members can navigate from one industry (one of seven) to the other and view products/services ratings specific to it. Each rating in the table shows + and − ratings of each product/service (357).

The system's landing page also displays latest rating updates among users or members (355). Each rating is composed of: industry, product/service, rating and a read more option allowing user or members to read notes and tweets related to the rating (356).

FIGS. 3d and 3e show the system's rate a service provider page. Through this page, users or members can create a new rating and post it to the system to affect the overall rating. The votes are aggregated to post a collective vote in brand. That brand will be ranked among its peer competitors. A single rating is related to a product/service from one of seven industries available to users or members in drop down menus. Users or members vote along four criteria related to the product/service they chose in the previous step. The system supports voting through sliding buttons with weights varying from −5 to 5 and users or members can answer four optional questions before posting the rating or tweeting it and posting it at the same time.

FIG. 3f is the system's View Ratings Page. It allows users or members to view all the ratings for products/services among different industries by all users or members. Part 2 of the page gives access to the list of available seven industries and each linked with a set of products/services for users or members to choose from. For each rating (372) there is a set of information displayed: users or members who posted the rating along with a profile picture/avatar/icon, industry and product/service and a specific numerical score. More information such as notes and optional answers are also linked with each individual rating. At the bottom of the page, part 4 displays the overall rating of the product/service among all other products.

FIG. 3g is the system's Invite friends to vote page. This page allows users or members to invite friends and other social networks friends to rate a specific brand. This is mainly because users' or members' ratings can be magnified by inviting the community members to join the campaign, if they happen to share the same opinion on that specific brand. The system allows users or members to pick a product/service for friends to rate. It also offers the possibility for users or members to choose invite friends from different social networks by displaying a set of social network icons.

FIG. 3h is a continuation of FIG. 3g as it allows users or members to choose friends to invite, set the invitation details and send the invitation. FIG. 3i is the group's page. This page allows users or members to view information related to a specific brand group. It is composed of four main parts:
1. Description of the group.
2. Members of the group. The user or member can consult members' profiles and interact with them.
3. Possibility of joining the group to be able to invite friends and receive promotions and offer codes.
4. Possibility of inviting friends. The user or member is able to perform this action only after joining the group.

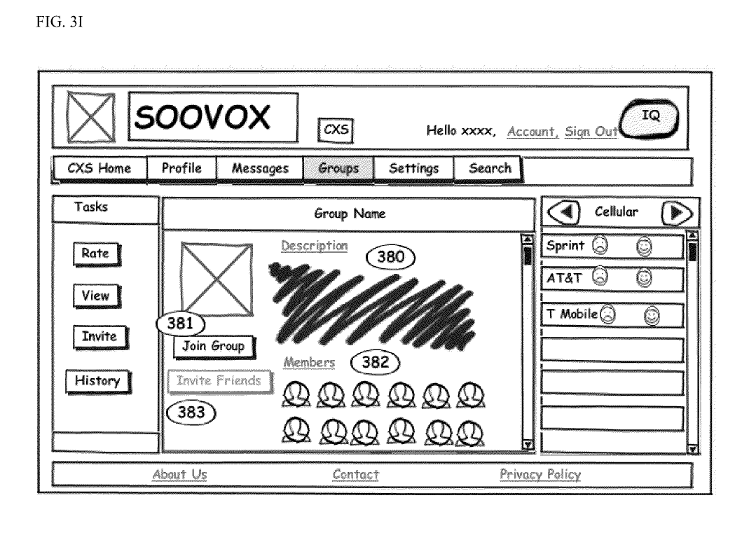

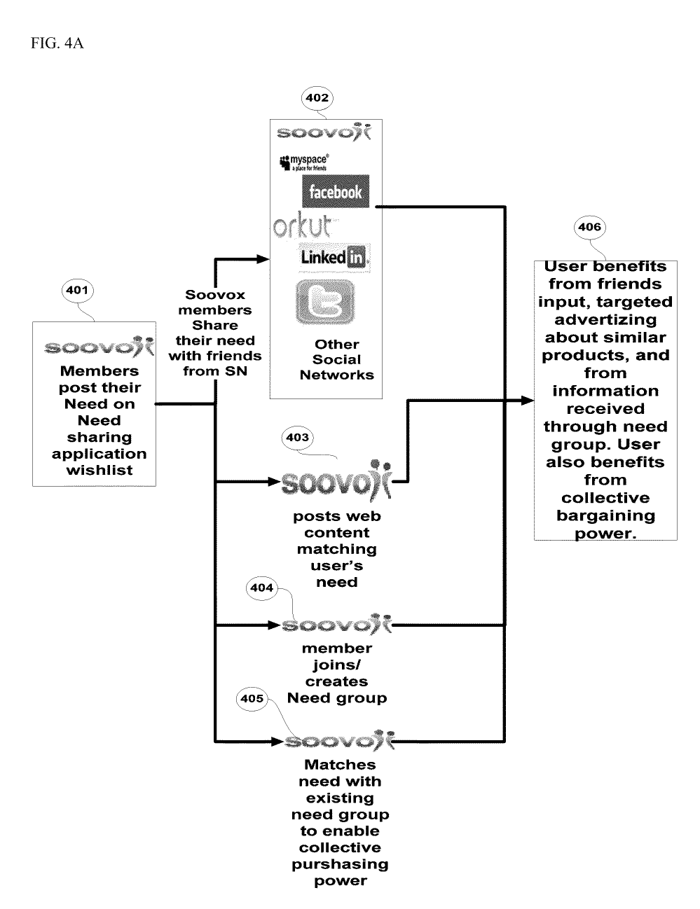

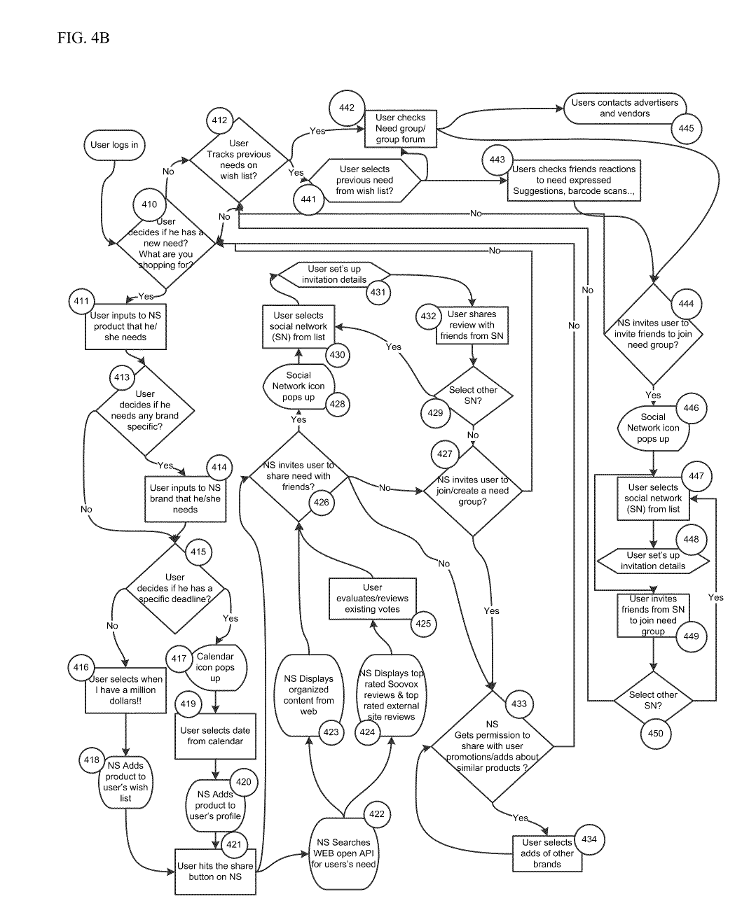

The application described in FIG. 1 includes also the Need Sharing engine NS (105). The Need Sharing (NS) application shown in FIGS. 4a, 4b is detailed next. NS is a shopping assistance application where the users or members research other users' or members' comments on the item he/she is shopping for. The application also allow the user or member to receive aggregated reviews from top review sites, and shopping assistance from connections(friends or followers) on social networks sites who will share available deals they find both online and offline. NS allows users or members to shop better for any product or service they look for, through leveraging existing web technologies (Google, Seenet . . . ) and social networks to find the best deal.

FIG. 4a gives a high level description of the Need Sharing application; once Soovox members post their need on NS (401), they can share their need with their connections on Soovox and other major social networks (402), Need Sharing presents the user or member with aggregated reviews from top review sites (403). Need sharing matches the user's or member's need with existing need groups to enable collective purchasing power(405), it also gives the user or member the option to join or create a need group (404). The user or member benefits from friends input, targeted advertising about similar products, and from information received through need group, user or member also benefit from collective bargaining power (406).

FIG. 4b shows details of an exemplary workflow for NS. First, a user or member logs into the system. Next the user or member decides if he/she wants to share a new need (410) in which case he/she inputs in NS his/her need (411) and he/she may also specify a specific brand (413, 414). If the user or member does not have a deadline by which his/her need has to be met (416) then his/her newly expressed need is added to his/her wish list, otherwise he/she gets to specify his/her deadline (419) on a calendar that pops up (417), NS proceeds to adding the user's or member's need to his/her profile (420). At this point the user or member activates the share need button (421) in NS. As a response to the user or member request, NS search WEB open API for user or member's need (422) then NS may displays organized content from the web (423) and may as well displays top rated Soovox reviews & top rated external site reviews (424) which are evaluated by the user or member (425). At this point, the user or member can share the reviews (432) with his/her connections from major social networks, in which case the user or member selects a social network (430) from a social network list (428), where he/she sets up invitation details (431), then shares reviews with his connections (432), and even has the option to invite friends from other major social networks (429). The user or member has also the option to join or create a need group (427). At this point, NS gets permission to share with the user or member advertising about similar products (433).

The user or member may also be interested to track his/her previously expressed needs saved in their wish list (412). In this case, the user or member selects a need from his/her wish list (441), and then checks how his/her connections/friends reacted (443) to the need expressed (suggestions, barcode scans . . . ). At this level, the user or member has the option to invite his/her connection to join a need group to which he/she belongs (142), this results in a social network icons popping up (446) where the user or member selects a network (447), sets invitation details (448), and invites friends (449) and possibility chooses to invite more friends from other major social networks (450).

NS users or members can also choose to explore/check need group forum (442) and then possibly contact vendors and advertiser as a group (445).

The system includes a Marketplace, which is an e-commerce exchange where Marketers acquire content and advertising channels. The market place is also where users or members sell their influence to advertisers both by brands and by geo location. The marketplace is described in FIGS. 5a-5c. The Marketplace enables marketers to only acquire digital real estate where they can display their advertising (videos, text content, and widgets). Businesses have access to “Geo Adpush” which is a location based advertising marketplace application that they can use to advertize and run awareness campaigns through influencers who patronize their establishments.

FIG. 5a gives a high level description of Soovox Market place; After Soovox marketers and business members set up a new campaign (501) and define its requirements and terms, Soovox market place matches influencers based on Social IQ and user or member preferences with available campaigns (502). Eligible Soovox Influencers proceed to advertising content on Social networks and get paid per Social IQ unit (503). Social networks deliver content to influencer's connections (friends and followers) (504).

FIG. 5b shows details of an exemplary workflow for advertising through Soovox Market place. When a business/brand chooses to advertise through Soovox Market place, it goes through the steps in FIG. 5c where the users or members begin by defining the components of the campaign including a brief description and type of the campaign (video, text, or widget), then the business user or member specifies the required level of influencers and Social IQ for the campaign. Next, the business user or member defines his budget by specifying how much he is willing to pay/bid per IQ unit. (Ex: $0.05/unit =>$20 for an IQ of 400), later the business user or member posts the campaign as a link or as a code, then authorizes payment and submits his proposal. The flowchart in FIG. 5c represents the details of step (511) in FIG. 5b. Once Soovox validates the completeness of the campaign (512), Eligible Soovox users or members who are already in the buzz sphere and meet the criteria required by the marketer (i.e.: Brand Badge, gender, location . . . ) are notified (513). Notifications are sent on Soovox and/or by mail, or through other social networks (Facebook, twitter, MySpace . . . ). The user or member can accept the invitation if interested. When they accept (515), the user or member takes the survey or advertizes (once) according to the marketer requirements (posting video, widget, link . . . ) (516). Once they perform the action, the user or member gets paid (519) through PayPal depending on his Social IQ after validating (518) his participation by the marketer.

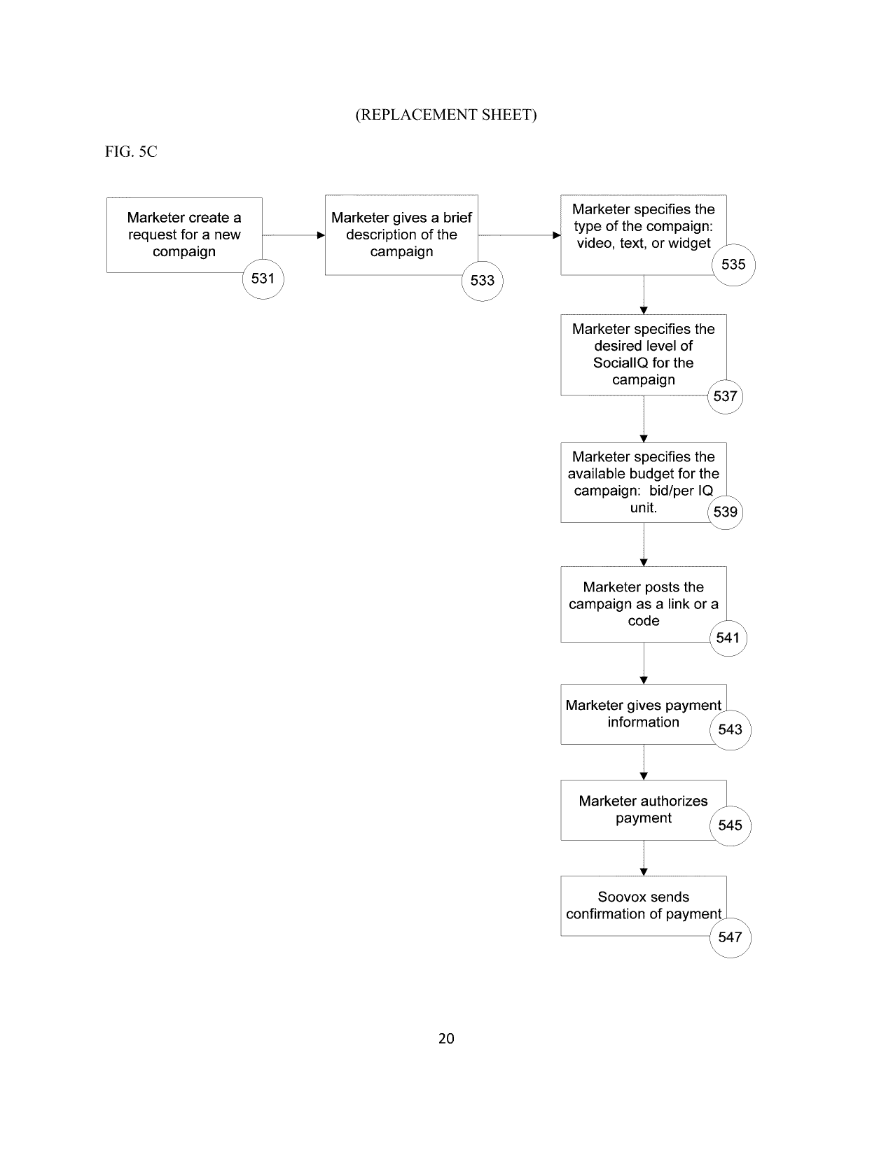

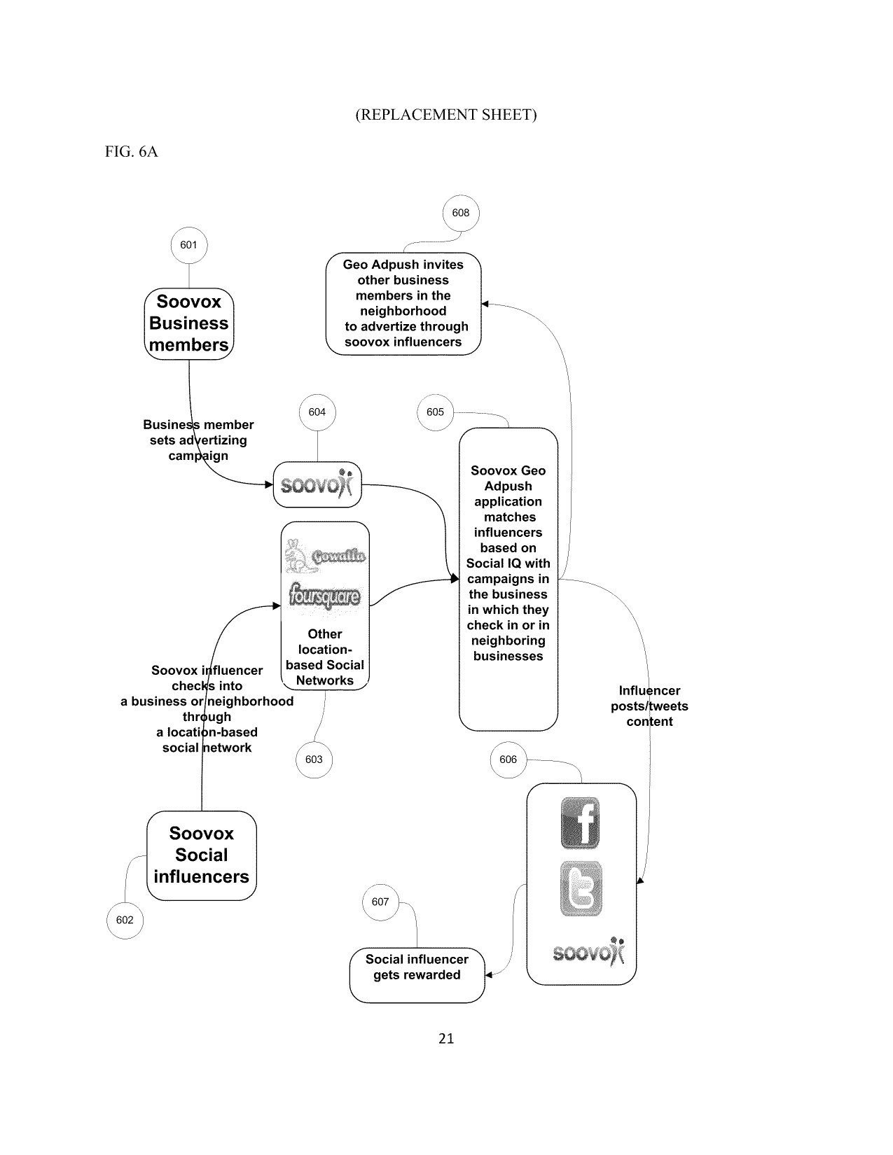

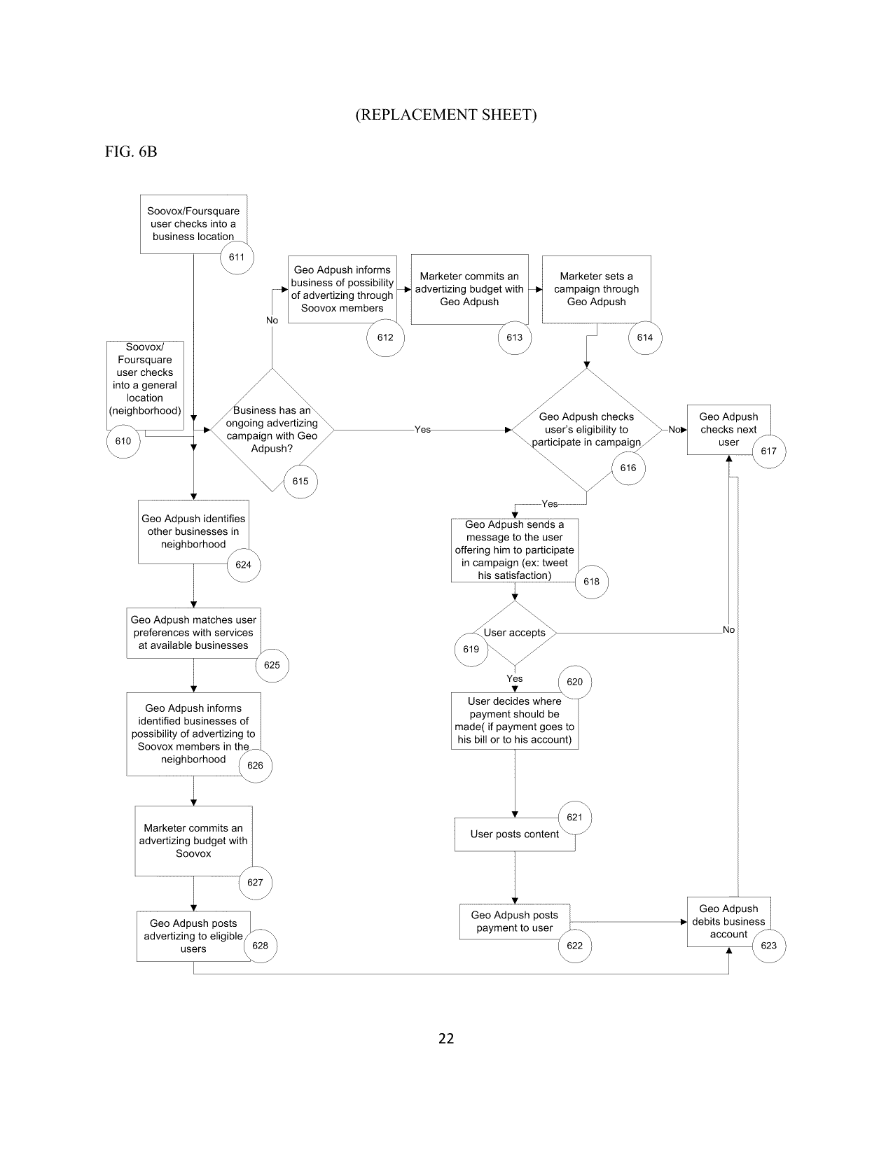

Next, a description of Geo Adpush application is shown in FIGS. 6a-6b. The Geo Adpush market place application leverages open APi's of geo APi sites like foursquare and Gowala to originate the advertising opportunity for the businesses, and connect them with the influencers to make a micro advertising deal or get business intelligence.

FIG. 6a gives a high level description of the Geo Adpush application. Once Soovox influencers(users) (602) check in through a location based social network such as Foursquare or Gowalla (603), into a location of a Soovox business member (601) or into a general location with an ongoing campaign, Soovox Geo Adpush application (606) matches influencers based on Social IQ with campaigns in the business in which they check in. When Soovox influencers participate in campaign by posting content to their connection through major social networks (606), they get rewarded (607) based on their social IQ and the campaign terms. Soovox invites other businesses in the neighborhood with ongoing advertising campaigns with Soovox to advertise to Soovox influencers in the neighborhood (608).

FIG. 6b shows details of an exemplary workflow for advertising through Geo Adpush. A Soovox/Foursquare user or member can check into a business location (611) or into a general location (610) through Foursquareor any other location based social network. When the user or member checks into a business location (611), two processes are conducted concurrently. In the first process, Geo Adpush checks if the business has an ongoing advertising campaign with Soovox (615), if not Geo Adpush informs the business of the possibility to advertize through Soovox users or members (612) and talks the business into creating and setting a new campaign (613 and 614). If the user or member is eligible to participate in campaign (616), Geo Adpush sends a message to the user or member offering him/her to participate in campaign (ex: tweet his/her satisfaction), then the user or member decides where payment should be made (if payment goes to his/her bill at current business or to his/her account) (620) after which the user or member posts the content (621) and receives his/her payment (622). Geo Adpush then debits the business account (623).

In the second process, Geo Adpush identifies other businesses in the neighborhood (624) then matches Soovox/Foursquare user or member preferences with available services at neighboring businesses (625) then Geo Adpush informs identified businesses of possibility of advertising to Soovox members in the neighborhood (626), after which the business can commit an advertising budget with Soovox (627), then Geo Adpush posts advertising to eligible users or members (628) and the business account is debited (623) appropriately depending on the Soovox user's or member's action.

If the user or member checks into a general location (610) such as a neighborhood, then the second process of FIG. 6b described above can also be triggered; In which case Geo Adpush identifies businesses in the neighborhood (624) and proceeds to steps (625, 626, 627, 628 and 623) as explained above.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

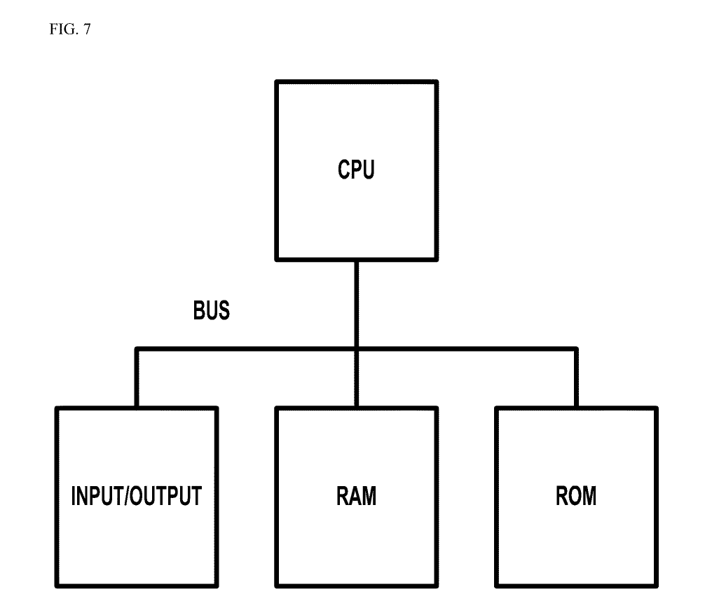

By way of example, FIG. 7 shows a block diagram of a computer to support the system. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A computer implemented method for location based branding, comprising:
checking into a business or a general location using a location based social network;
determining if the business or other businesses in the neighborhood are running an advertising campaign and if so
matching one or more influencers with a predetermined social influence (Social IQ) score with an existing campaign; and
transmitting social influence messages from the influencers who have checked into the business's location or are in the neighborhood and who are participating in the campaign.

2. The method of claim 1, comprising informing the business and other businesses in the neighborhood of the possibility to create a new advertising campaign.

3. The method of claim 1, comprising determining the influencer is eligible to participate in a campaign and offering the influencer to participate in campaign.

4. The method of claim 3, comprising providing an incentive for the influencer to post content.

5. The method of claim 4, comprising paying the influencer and debiting an account associated with the business.

6. The method of claim 1, comprising identifying neighboring businesses in the neighborhood matching the influencer's preferences with available services at the neighboring businesses.

7. The method of claim 6, comprising informing the neighboring businesses of a possibility of advertising to members in the neighborhood, receiving a commitment from one of the neighboring businesses and posting advertising to eligible users or members depending on the influencer's action.

8. The method of claim 1, comprising using a social network to communicate user or member interests and influences how services are provided or how products are made.

9. The method of claim 1, comprising a measurement system for measuring social influence power of users or members (Social IQ).

10. The method of claim 9, wherein the Social IQ measures a member's ability for influencing brands of products or services across the different stages of a product or a service life cycle.

11. The method of claim 1, comprising sharing a Consumer Experience (CXS) on line.

12. The method of claim 11, comprising sharing review on a specific service purchased, vote a level of satisfaction, and invite friends on social networks to see the review and vote along.

13. The method of claim 1, wherein the member shares the item being shopped, to receive aggregated reviews from top review sites, and shopping assistance from friends on social networks sites who will share available deals they find both online and offline.

14. The method of claim 1, comprising gathering advice and collective bargaining power by grouping people with the same need as one buyer.

15. The method of claim 1, comprising providing access to need groups and group forums that may help him/her satisfy their need.

16. The method of claim 1, comprising maintaining a wish list for unmet needs and receiving notification of a match for the unmet needs by a product or service provider.

17. A computer system for location based branding, comprising:
means for checking into a business or a general location using a location based social network;
means for determining if the business or other businesses in the nieghboorhood are running an advertising campaign and if so
means for matching one or more influencers with a predetermined social influence (Social IQ) score with the campaign; and
means for transmitting social influence messages from the influencers who have checked into the neighborhood or a business location.

18. The system of claim 17, comprising means for informing the business of the possibility to create a new advertising campaign.

19. The system of claim 17, comprising means for determining if the influencer is eligible to participate in a campaign and offering the influencer to participate in the campaign.

20. The system of claim 19, comprising means for providing an incentive for the influencer to post content.
